(19) United States
(12) Patent Application Publication
(10) Pub. No.: US 2002/0185347 A1
(43) Pub. Date: Dec. 12, 2002

(54) SPRING/MASS VIBRATORY FORCE COUPLER

(76) Inventors: ANDREAS POHL, GROSS-UMSTADT (DE); HORST ROSENFELDT, DARMSTADT (DE); ECKHARDT WENDT, LEVERKUSEN (DE); KLAUS BUSING, LEVERKUSEN (DE)

Correspondence Address: NORRIS MCLAUGHLIN & MARCUS, PA, 220 EAST42ND STREET, 30TH FLOOR, NEW YORK,, NY, 10017, US

(21) Appl. No.: 09/402,155

(22) PCT Filed: Apr. 15, 1998
(86) PCT No.: PCT/EP98/02206

(30) Foreign Application Priority Data
Apr. 26, 1997 (DE) 197 17 692.5

(51) Int. Cl. F16F 7/10; F16F 9/53

(52) U.S. Cl. 188/267.1; 188/267.2

(57) ABSTRACT

The invention relates to an electrically variable spring/mass vibrating force coupler with variable damping, electrically adjustable spring characteristic curves and electrically adjustable, variable natural frequencies using electro-rheological or magneto-rheological fluids in its coupling elements to couple masses and springs

The invention relates to an electrically variable spring/mass vibratory force coupler with variable damping, electrically adjustable spring characteristics and electrically adjustable variable natural frequencies using electrorheological or magnetorheological fluids (referred to below as ERF and MRF respectively for short) in its coupling elements to couple the masses or springs. The spring/mass vibratory force coupler makes it possible to adjust vibratory forces electrically and, in particular, to vary the natural vibration behaviour of various machines and apparatuses such as balancing machines, testing machines, gear mechanisms, engines/motors and mountings of various kinds as a function of an electrical and/or magnetic control signal.

Dampers based on ERF and MRF are known. Coupling masses to vibrating systems by means of a fixed spring member and a damping member which can be controlled by means of an electrorheological fluid is fundamentally known.

The article entitled “Einsatzpotential von elektrorheologischen Flüissigkeiten” [Potential uses for electrorheological fluids] by H. Janocha and D. J. Jendritza in Konstruktion 46 (1994), pp 111-115 describes mass coupling by means of a spring/damper system in which the spring stiffness is held constant and the damping can be varied by means of an electrorheological fluid. It also describes the coupling of an auxiliary mass for absorbing vibrations to a main mass by means of a spring/damper element. Coupling is likewise accomplished by a combination of a spring with a fixed spring stiffness and an ERF damper member by means of which the damping can be varied. This arrangement allows the amplitude of a mechanical vibration to be damped in the case of resonance. A significant disadvantage of this arrangement, however, is that the damping is only effective at a particular fixed frequency. Variation of the resonant frequency is not possible with this arrangement.

Coupling spring elements of various kinds to vibrating systems via conventional valves for the purpose of damping or suspension is also known. One example that may be mentioned of this is the system known as “hydroactive suspension” developed in the automotive sector, which uses special gas-pressure springs that can be connected up to the wheel suspension mechanisms of motor-vehicle running gear by means of suitable valves in order to damp the vibrations of the said motor-vehicle running gear.

To ensure good ride comfort, suspension with a high degree of flexibility and low damping is desired. For good road holding and a high degree of safety when driving, on the other hand, a stiff suspension with a simultaneously high degree of damping is required. By opening and closing a solenoid valve, the hydroactive suspension system makes it possible to connect up another gas-pressure spring to the fixed gas-pressure springs installed in every wheel suspension system, allowing two states, namely

a) high spring flexibility with low damping and

b) low spring flexibility with high damping to be set.

One disadvantage of hydroactive suspension is that the suspension system can only be varied between the two states mentioned. Continuous adjustment of the damping or continuous adjustment of the spring stiffness cannot be achieved in this spring system.

The possibility of using electrorheological fluids for continuous variation of the damping of motor-vehicle shock absorbers is described in SAE publication 950 586 of 27.2.1995. In the shock absorber described there, the piston of the shock absorber forces an electrorheological fluid through an electrode gap. The damping of the shock absorber can be continuously varied by means of the influence of an electrical high-voltage field caused by the capacitor in the electrode gap. Conventional shock absorbers based on viscous oils are generally combined with a coil spring with the result that, fundamentally, it is only possible to vary the damping but not the spring stiffness when using the said electrorheological damper on a traditional spring/shock absorber combination.

The possibility of using electrorheological fluids in hydraulic systems is fundamentally known. Thus, electrorheological fluids are proposed, for example, in shock absorbers (see, for example, U.S. Pat. No. 3,207,269) or engine mounts with hydraulic damping (see, for example, EP 137 112 A1).

The object on which the invention is based is to develop a spring/mass vibratory force coupler which allows variable damping of mechanical vibrations of vibrating devices coupled to the spring/mass vibratory force coupler, simultaneously permits continuous variation of the spring stiffness and, if required, permits coupling of additional masses to the vibrating system in order to change the mechanical natural vibration frequency and its amplitudes.

The subject matter of the invention by means of which this object is achieved is a spring/mass vibratory force coupler with variable damping for coupling masses to a reference mass, comprising at least a vibrating mass, referred to below as a vibratory mass for short, a damper, two springs for connecting the vibratory mass and reference mass, of which at least one spring can be connected up optionally, if required another auxiliary mass, which is connected to the mass by a spring/damper element which can be connected up if required, the spring or, if required, the auxiliary mass being connected up by means of coupling elements based on an electrorheological or magnetorheological fluid.

Additional masses can preferably be connected up by means of additional selectable spring/damper elements, thereby, for example, allowing absorption of mechanical vibrations.

It is furthermore possible to connect additional spring/damper coupling elements between the vibrating mass and the reference mass, these elements altering the spring stiffness of the spring connection between the mass and the reference mass. The spring/damper coupling elements are, in particular, embodied as a combination of known spring elements, such as torsion, coil, bending or longitudinal springs or gas-pressure springs combined with dampers based on electrorheological fluids or magnetorheological fluids. An example of a damper based on electrorheological fluids can be found in U.S, Pat. No. 3,207,269.

In the simplest case, the coupling elements are dampers which are based on electrorheological fluids or magnetorheological fluids and in which a strong connection can be produced between vibrating masses by means of a sufficiently high adjustable yield strength of the ERF (or MRF). Below the maximum yield strength of the ERF (or MRF), the ERF or MRF damper has continuously adjustable damping.

The coupling elements based on electrorheological fluids are activated by means of electrical voltages, by means of which the capacitors contained in the coupling elements build up electric fields to control the rheological variable yield strength and the modulus of the electrorheological fluids.

The term electrorheological fluids is intended to indicate dispersions of finely divided electrically polarizable particles in hydrophobic, electrically highly insulating oils (generally a suspension of electrically polarizable, non-conductive particles) which, under the action of an electric field of sufficiently high electric field strength, quickly and reversibly change their yield strength or their shear modulus, under certain circumstances over several orders of magnitude. In the process, the ERF may change from the low-viscosity, via the plastic, almost to the solid state of aggregation.

Examples of suitable electrorheological fluids are mentioned in German Offenlegungsschriften (German Published Specifications) DE 35 17 281 A1, DE 35 36 934 A1, DE 39 41232 A1, DE 40 26 881 A1, DE 41 31 142 A1 and DE 41 19 670 A1.

Both direct-voltage and alternating-voltage fields are used to excite the electrorheological fluids. The electric power required here is comparatively low.

To control the flow behaviour of the electrorheological fluid in the coupling elements, use can be made of a sensor such as that described in German Offenlegungsschrift (German Published Specification) DE 36 09 861 A1.

The spring/mass vibratory force coupler according to the invention can be used in machines of all kinds to modify mechanical natural vibrations. Examples that may be mentioned here are balancing machines, machine tools, unbalanced generators, testing machines, resonance testing machines, alternate bending machines, screen conveyors, eccentric presses, crank mechanisms, vibratory and resonance drives and vibratory gear mechanisms, engines/motors and mounts of all kinds. The spring and/or mass coupling according to the invention makes it possible to compensate for engine vibrations of vehicles and other mechanical vibrations.

The fundamentally known hydroactive suspension system can be varied as follows using the concept according to the invention of the spring/mass vibratory force coupler: the hydraulic fluid of the suspension system, which is known in principle, is replaced by an electrorheological fluid. The flow passages of the main dampers of the suspension system have electrorheological valves (electrode gaps) added. An additional selectable further gas-pressure spring is coupled to the gas-pressure springs of the running gear by means of controllable electrorheological valves instead of by means of conventional dampers and solenoid valves. This preferred embodiment of the invention provides damping or spring stiffness that can be controlled in a versatile manner and can be adjusted within wide ranges, depending on the driving situation or the state of the roadway. Since electrorheological fluids can typically respond to changes in an electric field within less than 5 milliseconds, it is possible to achieve the desired change in the damper/spring characteristics at high speed by means of suitable sensors and electronic control devices. The flow in an electrorheological valve is dependent on the flow rate of the ERF. It is therefore possible to employ this effect directly as a sensor for monitoring and controlling the damping system, in accordance with patent specification EP 238 942.

The invention is explained in greater detail below by way of example with reference to the drawings, in which:

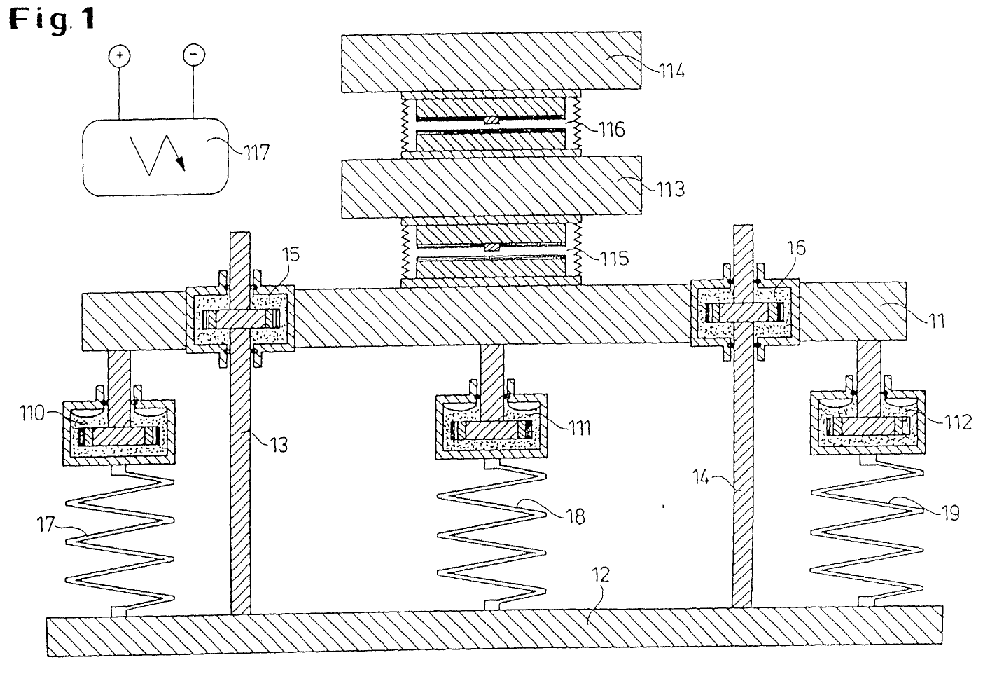

FIG. 1 is a schematic representation intended to illustrate the spring/mass vibratory force coupler according to the invention in cross section,

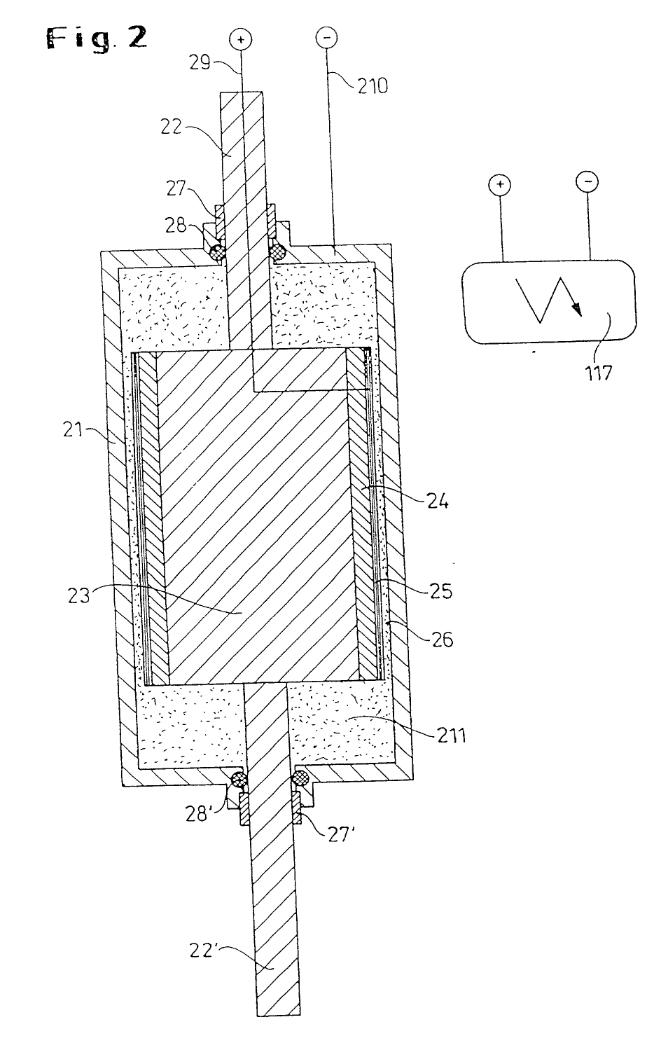

FIG. 2 shows an ERF coupling or damper element 15 from FIG. 1 in enlarged cross section.

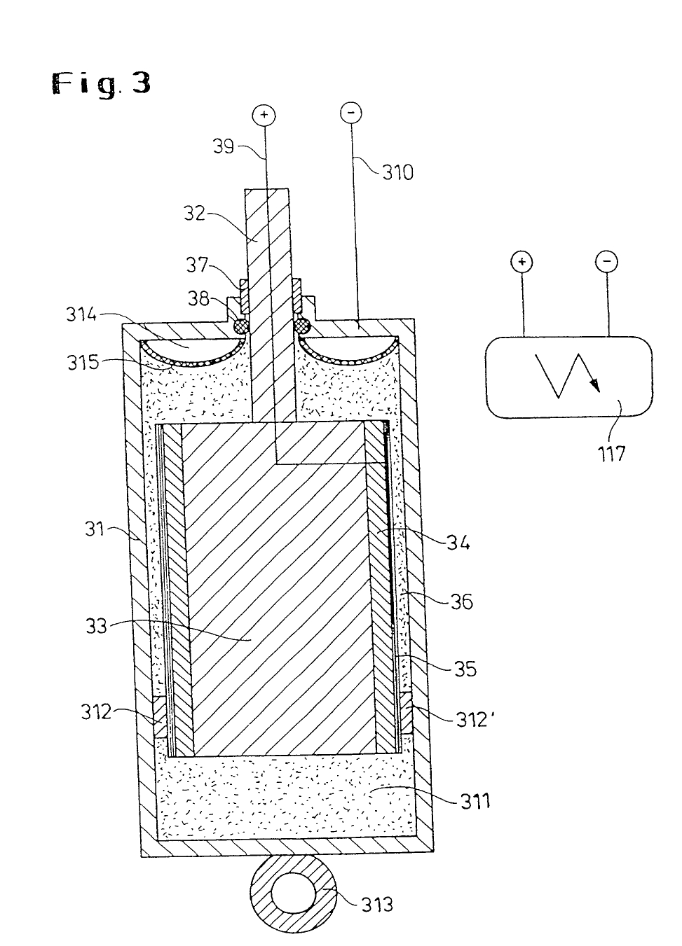

FIG. 3 shows an ERF coupling element 110 from FIG. 1 in enlarged cross section.

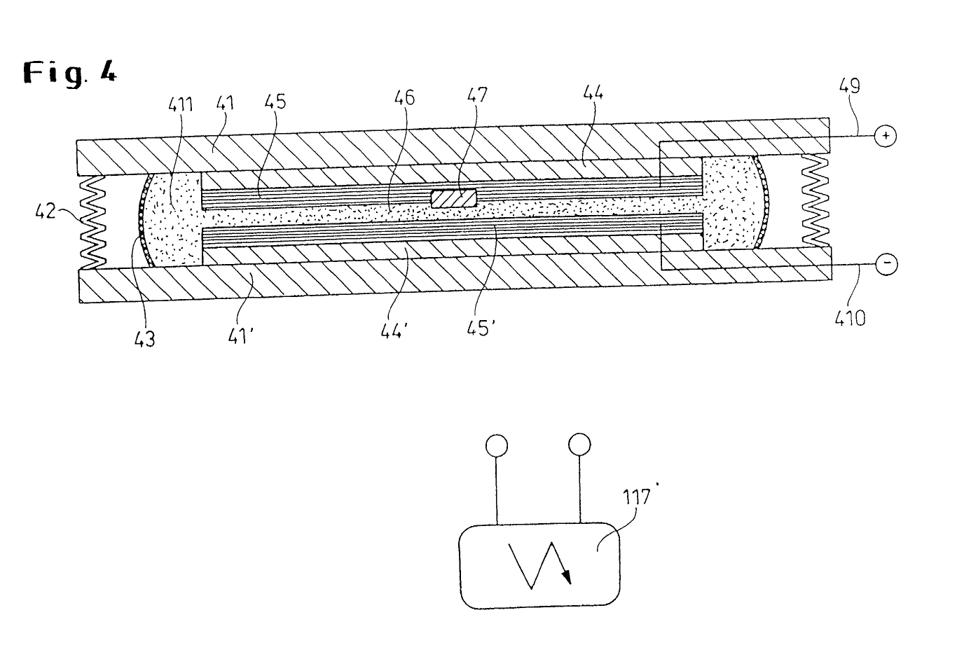

FIG. 4 shows a spring damper coupling element 115 based on an ERF from FIG. 1 in enlarged representation

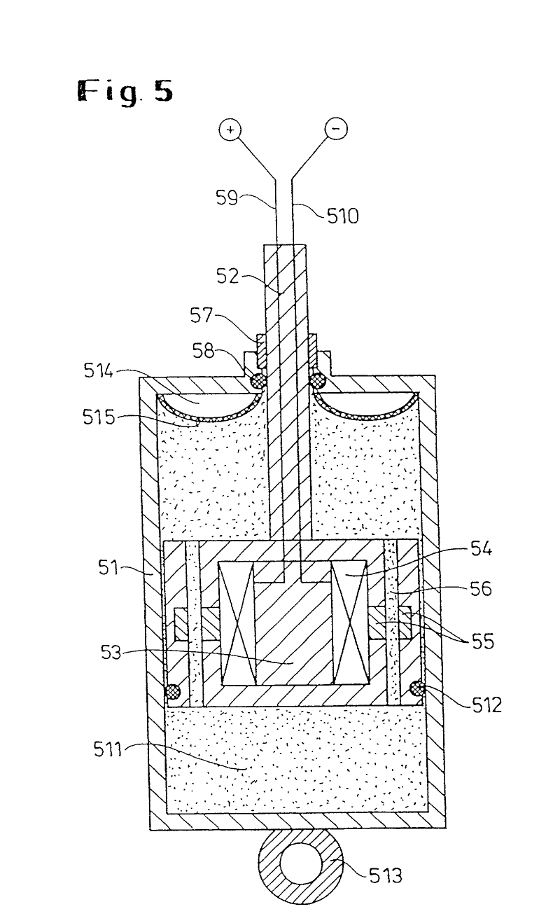

FIG. 5 shows an MRF coupling element 112 for coupling the spring 19 in FIG. 1, shown in an enlarged cross section.

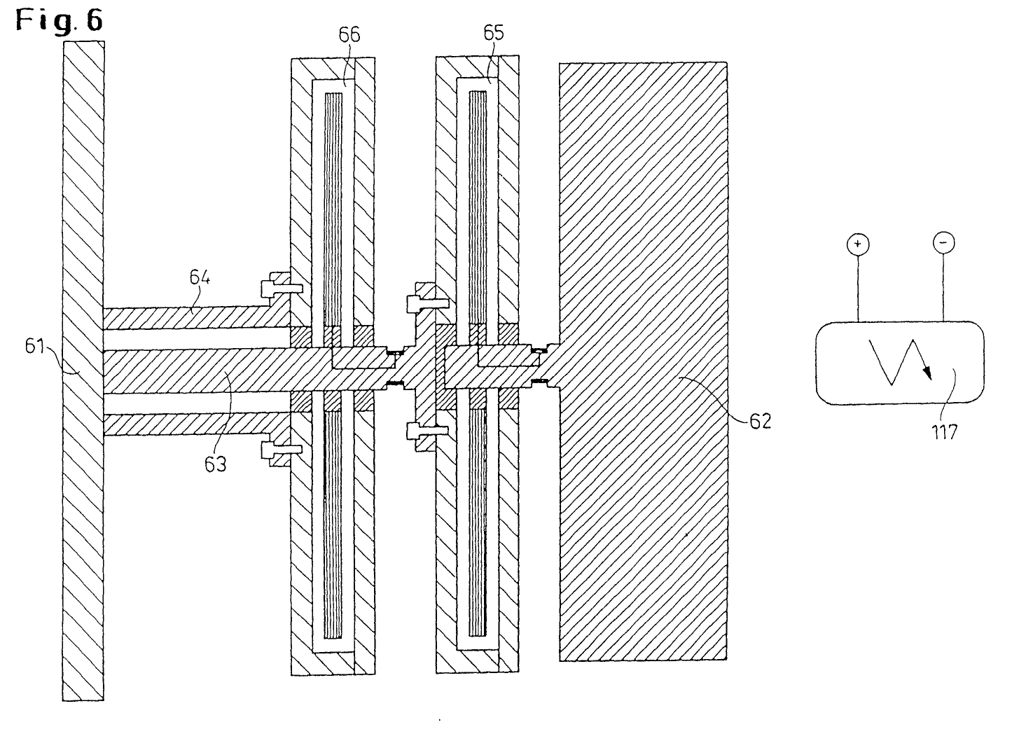

FIG. 6 shows an embodiment of the spring/mass vibratory force coupler with torsion springs as spring elements, in cross section.

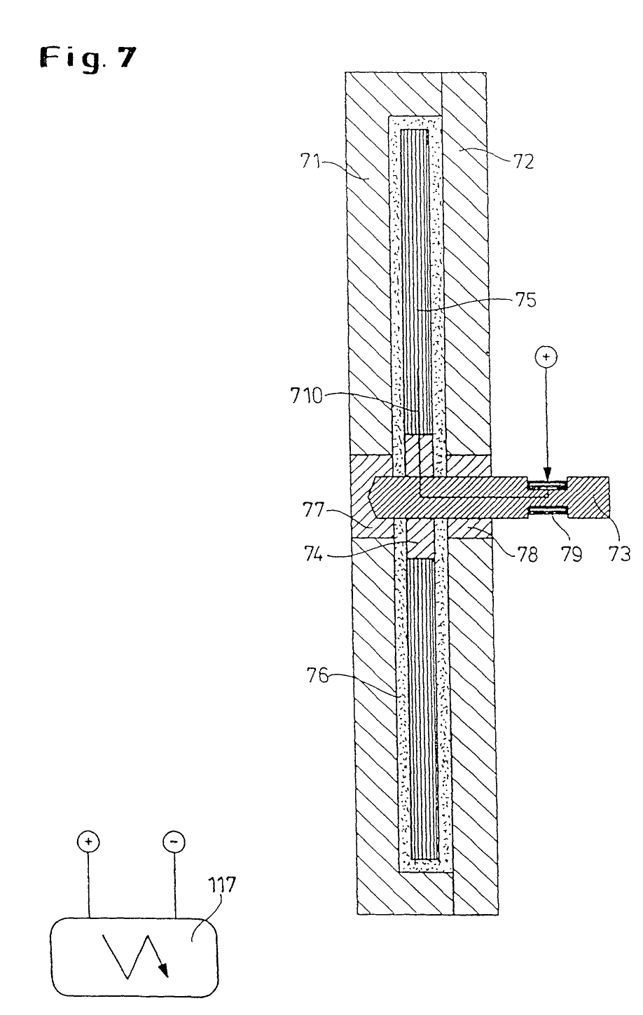

FIG. 7 shows a simplified cross section through an ERF coupling element 67 in accordance with FIG. 6 for coupling a mass to a torsion spring 64.

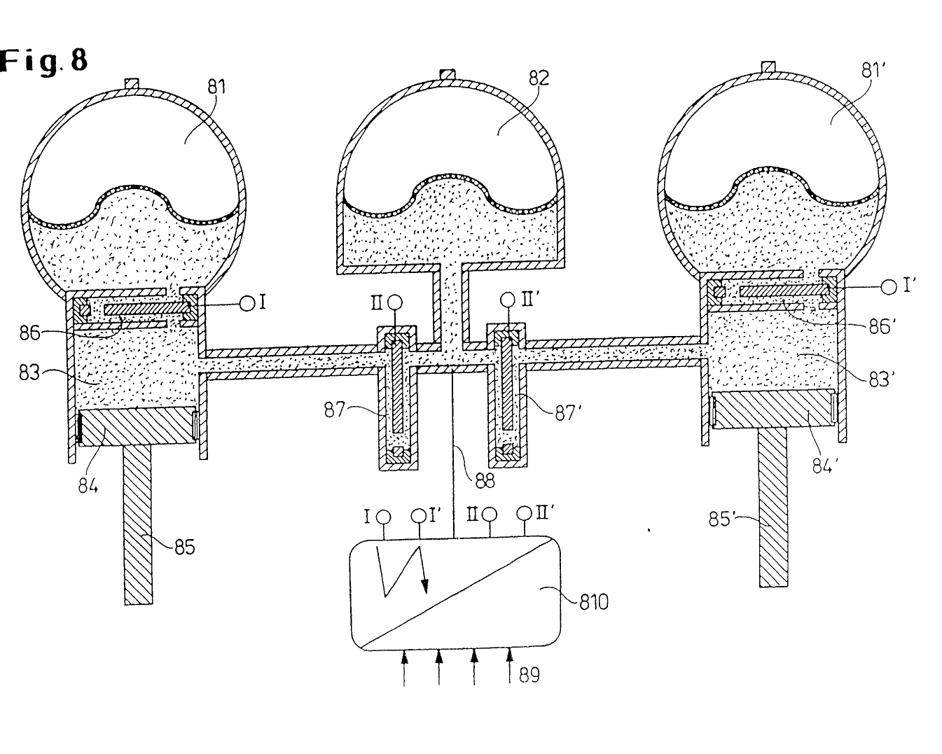

FIG. 8 shows the use of a spring/mass vibratory force coupler element according to the invention in a “hydroactive suspension”.

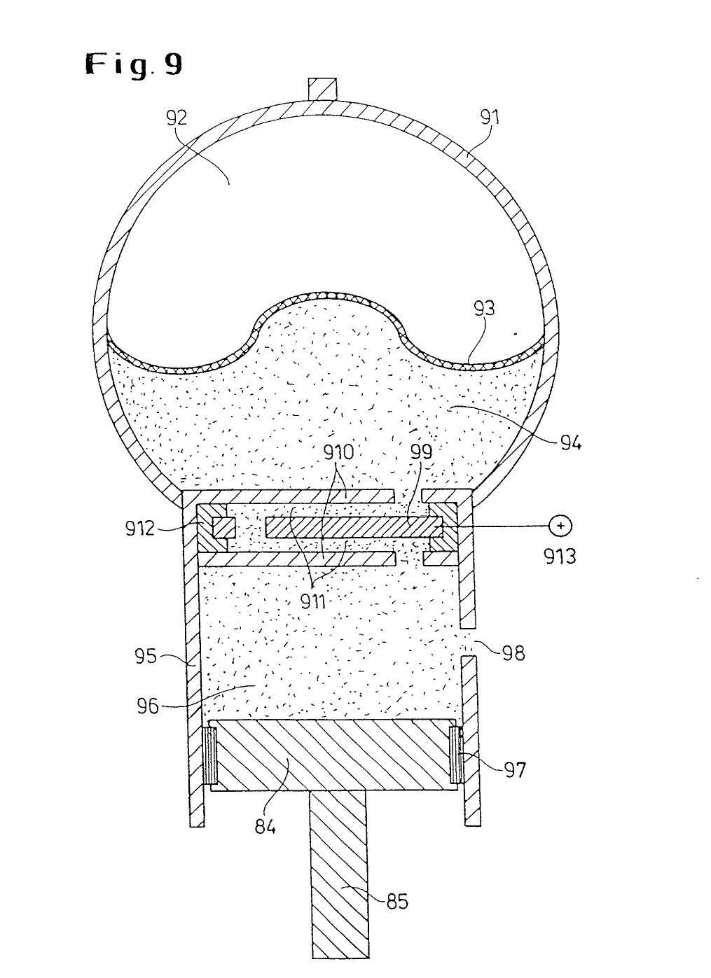

FIG. 9 shows an enlarged schematic cross section through a pneumatic spring ball 81 with the ERF damper element from FIG. 8.

### EXAMPLES

### Example 1

The invention is illustrated by way of example in the schematic section in FIG. 1. The reference mass 12 is connected to the vibratory mass 11 by 3 selectable spring/damper elements 17, 110, 18, 111 and 19, 112. The spring/damper elements 17, 110, 18, 111 and 19, 112 are combinations of conventional coil springs 17, 18, 19 with dampers 110 or 111 based on electrorheological fluids or a damper based on a magnetorheological fluid 112. The vibratory mass 11 is also connected to the reference mass 12 at least by a firmly connected spring (not shown). In addition, the vibratory mass 11 is guided by means of guide rods 13, 14 with coupling elements 15, 16.

An absorber mass 113 is coupled to the vibratory mass by means of an ERF spring/damper coupling element 115 in order to absorb particular mechanical vibrations. The resonant frequency of the vibration of the absorber mass 112 can be shifted by means of an auxiliary mass 114, which is connected to the absorber mass by another spring/damper coupling element.

FIG. 2 shows a detail of the construction of the ERF coupling and damper elements 15 or 16 on the guide rod 13 or 14. The piston rods 22, 22′ are connected to the piston body 23, which can be moved in the housing 21 of the coupling elements 15 or 16. The housing 21 is filled with an ERF 211 and sealed off at the piston rods 22, 22′ by means of mechanical seals 28, 28′ and guide bushes 27, 27′. An electrical feed conductor 29 for the high voltage from the external voltage supply 117 is guided through the stem of the upper piston rod 22 and is passed through the insulator 24 to the electrode surface 25.

Applying a voltage between the housing 21 and the electrode 25 increases the yield strength of the ERF 211 in the annular gap 26. By applying a sufficiently high voltage, it is possible to activate the ERF 211 in such a way that a strong connection is achieved between the housing 21 and the piston body 23. This makes it possible to couple the vibratory mass 11 firmly to the reference mass 12.

FIG. 3 shows the construction of the ERF coupling element 110 or 111. The housing 31 is connected to a lug 313 for the attachment of the springs 17 or 18 and encloses the ERF 311 and the piston 33, which plunges into the ERF 311. The piston 33 is connected to the piston rod 32, which is attached to the vibratory mass 11. The piston rod 32 is guided through into the housing 31 in a movable manner via a seal 38 and a guide bush 37. The piston 33 is guided by means of an electrically insulating guide 312, 312′ which is pierced to allow the ERF to flow through the annular gap 36. The electrical high-voltage feed conductor is passed through the stem of the piston rod 32 and through an insulating layer 34 to the electrode surface 35. A compensating volume 314 in the upper part of the housing 31 is separated from the ERF 311 by a flexible diaphragm 315 and provides compensation for the volume of the piston rod 32, which also plunges into the housing volume 31. When an electrical voltage is applied to the electrode 35 opposite the housing 31, the viscosity of the ERF 311 in the electrode gap 36 is increased and damped or rigid coupling of the spring 17 or 18 to the vibratory mass 11 is made possible.

### Example 2

A variant of the spring/mass vibratory force coupler described in Example 1 operates with a coupling element based on a magnetorheological fluid (MRFC) for the purpose of coupling the springs and masses.

FIG. 5 shows a detail of an MRF coupling element 112, the operation of which is fundamentally comparable with that of the ERF coupling element 110 described above. The housing 51 contains the MRF 511, a compensating volume 514 behind a diaphragm 515, and a piston 53, which is connected to the vibratory mass 11 by the piston rod 52. The piston 53 is guided via a ring seal 512 and is designed to be movable in the housing 51. FIG. 5 shows a coupling member based on a magnetorheological fluid. The housing 51 contains a magnetorheological fluid and a piston 53 with an electromagnet 54 having electrical feed conductors 510 and 59 which are fed in via the piston rod 52. The piston separates two spaces 511 and 516 containing the magnetorheological fluid. The piston is penetrated by an annular gap 56 via which fluid can be exchanged between the spaces 516 and 511. When the electromagnet is switched on, a magnetic field is produced in the annular gap 56 outside the magnetic insulator 55 and the field lines of this magnetic field are perpendicular to the surface of the annular gap. The piston 53 is provided with a guiding seal 512 in relation to the housing 51, the said seal preventing the magnetorheological fluid from passing through between the housing wall 51 and the piston 53 when the piston 53 is moved. The piston rod 251 is passed into the housing via a bushing 57 with a ring seal 58. Compensating volumes 514 are additionally provided and these are separated from the magnetorheological fluid by a diaphragm 515. The compensating volume 514 serves to compensate for the increase in volume caused by the piston rod 52 as it is pushed in. Like volume 314 in FIG. 3, compensating volume 514 also simultaneously prevents cavitation in the spaces containing the magnetorheological fluid. The damping of the MRF damping member increases as the magnetic field strength in the annular gap 56 increases. Once the maximum yield strength of the MRF has been reached, rigid coupling of the masses connected to the rod 52 and the housing 51 via a fixing means 513 is possible.

### Example 3

In this example, the spring/mass vibratory force coupler shown in Example 1 has been supplemented by coupling in an absorber mass 113 and, if required, an auxiliary mass 114, as shown schematically in FIG. 1.

FIG. 4 shows the ERF coupling element 115 (or 116) for coupling the absorber mass 113 or the auxiliary mass 114 to the vibratory mass 11 on an enlarged scale. The end plates 41, 41′ are connected to a spring bellows 42. The ERF 411 is enclosed at the sides by a diaphragm 43 and between two capacitor plates 45, 45′, which are insulated by insulators 45, 45′ and connected to an external variable voltage source 117 by power supply conductors 49, 410. An insulating spacer 47 prevents a short circuit between the plates 44 and 44′ when a voltage is applied. When a voltage is applied, the ERF 411 between the plates 44 and 44′ can be activated in squeeze mode in the case of vibration coupling of the masses 113 or 114. By means of an alternating voltage, it is possible to produce a mechanical vibration of the mass 113 which vibrates in phase opposition to a vibration of the vibratory mass 11, for example. This makes it possible to absorb mechanical vibrations. The coupling element 116 can be used to couple the auxiliary mass 114 to the absorber mass 113 in order to influence the frequency of the vibration absorption by means of the absorber mass 113. The diaphragm 43 is preferably chosen so that its stiffness makes only a negligible contribution to the stiffness of the spring.

### Example 4

FIGS. 6 and 7 show a variant of the spring/mass vibratory force coupler according to the invention for coupling torques. In this variant, the vibratory mass 62 is coupled to the reference mass 61 by means of the electrorheological fluids 65 and 66 in the coupling elements 67 and 68 via two torsion springs 63 and 64. FIG. 7 shows the construction of the coupling elements 67, 68. An electrical conductor 710 is passed through the shaft 73 from the sliding contact 79 to the round electrode plate 75, which is surrounded by the ERF 76 in the housing 71, 72, with electrical insulation (by the insulator 74). The shaft is mounted rotatably in bushes 77, 78 which seal off the interior containing the ERF 76. In the case of coupler 67, the shaft is connected to the vibratory mass 62, as can be seen in FIG. 6. In the case of coupler 68, the shaft is part of the torsion spring 63 and is firmly connected at its upper end to the housing wall 71 of coupling element 67. The yield strength of the electrorheological fluid 65 or 66 is controlled by means of the voltage across the electrodes 75 or 711 and the housing of the coupling elements 67 or 68 acting as the opposite pole to the electrodes 75, 711. If, for example, a voltage is applied between electrode 75 and the housing 71, 72, the electrorheological fluid 65 between the housing 71, 72 and the electrode 75 becomes highly viscous and the vibratory mass 62 is connected by the electrode 75 connected to it to the spring 63. It is likewise possible, by applying a suitable voltage between electrode 711 and the housing 68, to make the electrorheological fluid 66 between them highly viscous and to couple spring 64 to spring 63. The vibratory mass 62 is then connected for vibration to the reference mass 61 by both springs 64 and 63. The electrorheological fluids 65, 66 then serve as a coupling medium.

### Example 5

FIG. 8 illustrates the use of the spring/mass vibratory force coupler in accordance with the invention with reference to a modified hydroactive spring system for motor vehicles. Mechanical vibrations and shocks transmitted to the wheels of the running gear by irregularities in the roadway are transmitted to the pistons 84 and 84′ by the wheel suspension mechanism of the running gear (not shown) and the piston rods 85 and 85′, respectively, connected thereto. The pistons 84, 84′ are provided with sliding seals 97 and force an electrorheological fluid 83, 83′ used as a hydraulic oil through ERF valves 86, 86′ into the chamber of the gas-pressure springs 81, 81′, in which a gas-pressure space 92 is separated from the hydraulic fluid 94 by diaphragms 93 (see FIG. 9). The electrode gap 911 is situated between the capacitor plate 99 and the housing 910 of the valves 86 and 86′, to which an electrical voltage can be applied in order to control the viscosity of the ERF. An insulator 912 prevents electrical breakdowns to the housing wall. An additional gas-pressure spring 82 can be connected to the hydraulic side of the pistons 84 and 84′ by additional electrorheological valves 87 and 87′ and corresponding feedlines 98. A sensor 810, which can detect irregularities in the roadway, is used to influence the voltage across the capacitor plates of the dampers 86, 86′ and 87, 87′. The control voltage of the sensor can likewise be used to activate or deactivate the additional pneumatic springs 82.

An additional fluid supply unit (not shown) with a pump for regulating the pressure level of the fluid in the hydraulic system can be connected to the hydraulic system.

When a magnetorheological fluid is used as the hydraulic fluid in the spring/mass vibratory force coupler, the electrorheological valves 86, 86′ and 87, 87′ are replaced by MRF valves, as shown in FIG. 5, in the system shown in FIG. 8.

1. Spring/mass vibratory force coupler with variable damping for coupling masses to a reference mass (12), comprising at least a vibratory mass (11), a damper (111), two springs (17, 18), for connecting the vibratory mass (11) and the reference mass (12), of which at least one spring (18) can be optionally connected up, the spring (18) being connected up by means of a coupling element (111) based on an electrorheological or magnetorheological fluid.

2. Device according to claim 1, characterized in that this additionally has at least one absorber mass (113), which is connected to the mass (11) by means of a spring/damper element (115) which can be connected up if required.

3. Device according to claim 2, characterized in that connection takes place by means of a coupling element based on an electrorheological or magnetorheological fluid.

4. Device according to claims 2 to 3, characterized in that it has at least one other auxiliary mass (114), which is connected to the absorber mass (113) by means of another spring/damper element (116), which can be connected up if required.

5. Device according to one of claims 1 to 4, characterized in that the spring/damper coupling elements are a combination of torsion, coil or gas-pressure springs with dampers based on electrorheological fluids or magnetorheological fluids.

6. Devices according to claim 5, characterized in that the spring elements are gas-pressure springs (81, 81′, 82).

7. Hydraulic suspension system based on two or more gas-pressure springs (81, 81′, 82), characterized in that one gas-pressure spring (81) has an ERF or MRF damper element (86) and is connected to another gas-pressure spring (82) by means of at least one other damper or coupling element (87) based on ERF or MRF.

8. Use of the devices according to claims 1 to 6 to modify mechanical natural vibrations in machines, vehicle running gear or motors, in particular balancing machines, machine tools, unbalance generators, testing machines, resonance testing machines, alternate-bending machines, screen conveyors, eccentric presses, crank mechanisms, vibration and resonance drives, vibratory gear mechanisms, internal combustion engines/electric motors or engine mounts.
